(19) United States
(12) Patent Application Publication
(10) Pub. No.: US 2008/0074881 A1
(43) Pub. Date: Mar. 27, 2008

(54) Backlight module

(76) Inventor: Been-Yu Liaw, Jhongli City (TW)

Correspondence Address: Troxell Law Office Pllc, Suite 1404, 5205 Leesburg Pike, Falls Church, VA, 22041, US

(21) Appl. No.: 11/526,078

(22) Filed: Sep. 25, 2006

(51) Int. Cl. F21V 29/00

(52) U.S. Cl. 362/294

(57) ABSTRACT

A backlight module is composed of a light module, a heat dissipation plate, and heat pipes, wherein the heat dissipation plate is embedded with one or more than one cavity which is corresponding to a point of light source, and the cavities are installed with the heat pipes. A space between the heat pipe and the cavity is emplaced with a solder paste which is heated to connect the heat pipe and the cavity. Next, the heat pipes and the heat dissipation plate are processed with a CNC (Computer Numerical Control) machine, such that the heat pipes and the heat dissipation plate can form into a complete plane, thereby enabling the backlight module to effectively achieve effects of heat transmission, temperature homogenization, and heat dissipation, and a problem of chromatic aberration created by the light module to be effectively prevented.

### BACKGROUND OF THE INVENTION

(a) Field of the Invention

The present invention relates to a backlight module, and more particularly to a backlight module which is used to transmit heat uniformly.

(b) Description of the Prior Art

Referring to FIG. 1 and FIG. 2, a conventional backlight module uses only a heat dissipation plate to perform a heat dissipation function, and its illuminant A1, heat of which is to be dissipated, includes one or more than one illumination element A2, with heat energy A3 of the illuminant A1 being generated by the illumination elements A2. A magnitude of the heat energy A3 of illuminant A1 is affected by emplacement positions of the illumination elements A2, and the closer a position is to the illumination element A2, the higher the temperature is. In addition, as the heat dissipation plate is only provided with an effect of heat dissipation, and is not provided with a function of homogenizing the temperature, the temperature difference will be excessively large at the position of illumination element A2 with higher heat energy A3, thus the heat energy A3 cannot be effectively removed, such that it will easily induce a problem of chromatic aberration to the illumination element A2 due to the high heat.

Accordingly, how to eliminate the aforementioned problems is a technical issue to be solved by the present inventor.

### SUMMARY OF THE INVENTION

The primary object of present invention is to provide a backlight module which is used to transmit heat uniformly, wherein cavities of a heat dissipation plate are installed with heat pipes which are corresponding to points of light sources, such that heat energy of the points of light sources can be effectively transmitted to the heat dissipation plate through the heat pipes, enabling the backlight module to achieve functions of transmitting heat, homogenizing temperature, and preventing the light module from creating chromatic aberration.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional backlight module.

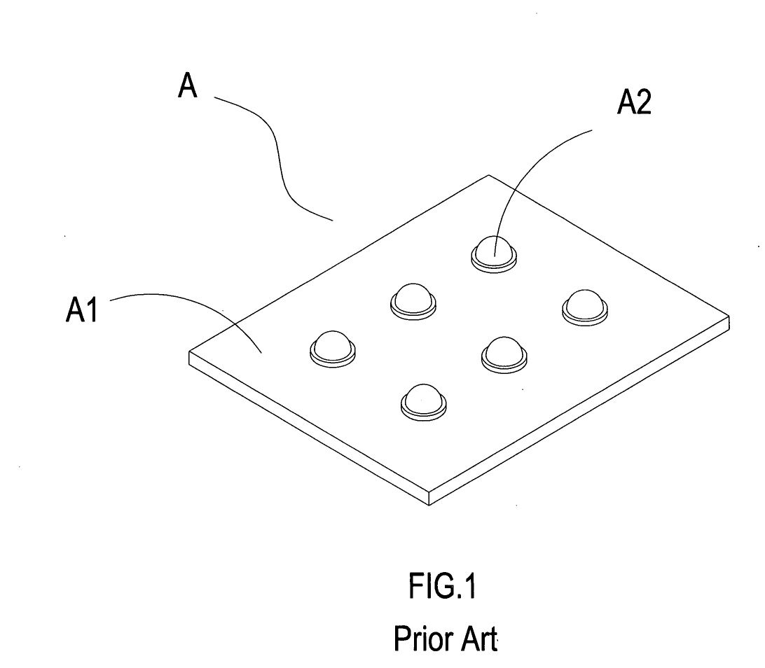

FIG. 2 shows a schematic view of heat energy of a conventional backlight module.

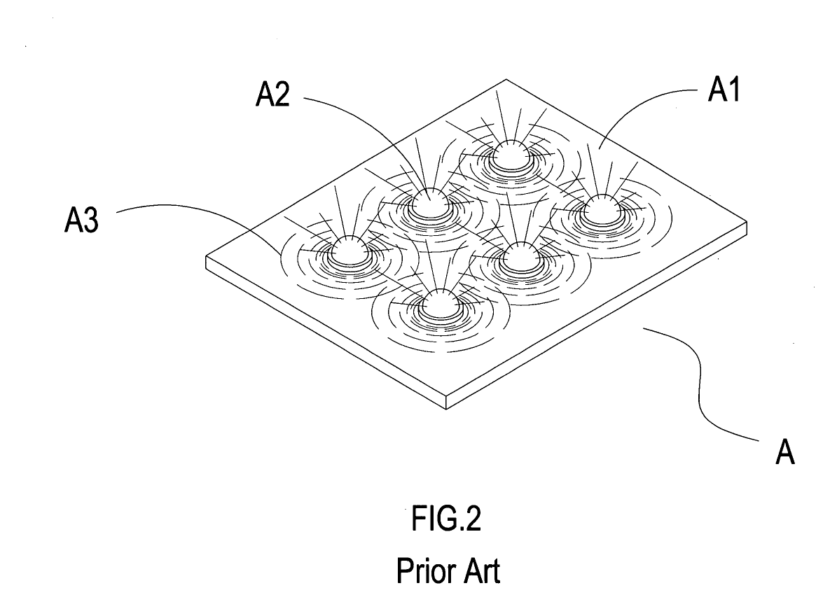

FIG. 3 shows a perspective view of the present invention.

FIG. 4 shows an exploded view of the present invention.

FIG. 5 shows a schematic view of heat energy of the present invention.

FIG. 6 shows a schematic view of an embodient of the present invention.

FIG. 7 shows a second schematic view of an embodient of the present invention.

FIG. 8 shows a third schematic view of an embodient of the present invention.

FIG. 9 shows a fourth schematic view of an embodient of the present invention.

FIG. 10 shows a fifth schematic view of an embodient of the present invention.

FIG. 11 shows a sixth schematic view of an embodient of the present invention.

### DETAILED DESCRIPTION OF THE PREFERRED EMBODIMENTS

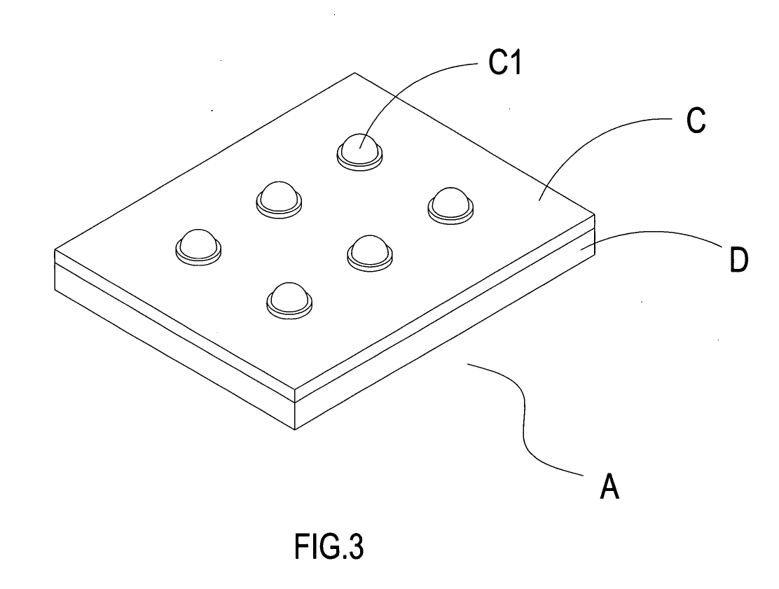

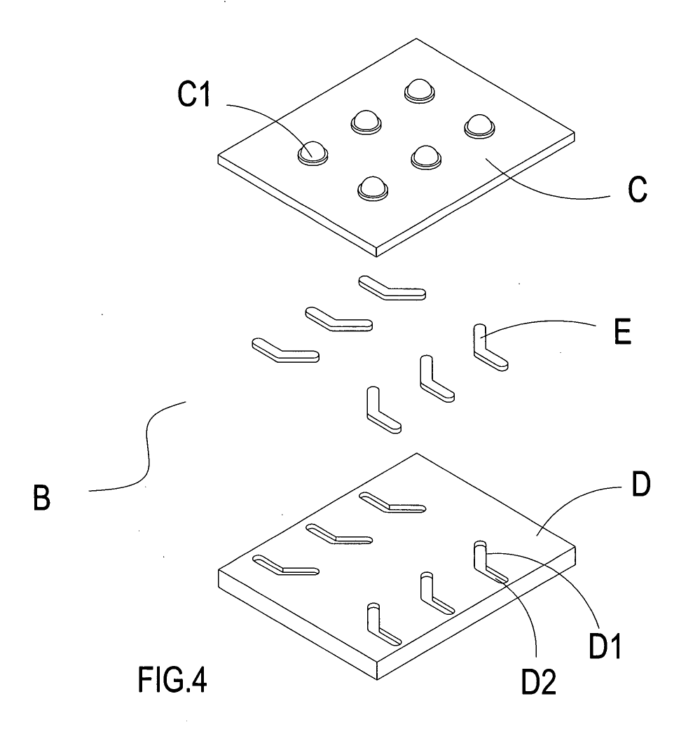

The present invention is to provide a backlight module. Referring to FIGS. 3 to 5, a backlight module B comprises primarily a light module C, a heat dissipation plate D, and heat pipes E, wherein the light module C includes one or more than one point of light source C1, and heat energy C2 of the light module C is created by the points of light sources C1, such that temperature at the point of light source C1 is higher than that at a position without the point of light source C1 in the light module C.

The light module C is affixed with a heat dissipation plate D to transmit the heat energy, the heat dissipation plate D is installed with cavities D1 which are corresponding to the points of light sources C1, and the cavity D1 is provided with a heat pipe E which is used to uniformly transmit the heat energy C2 transmitted by the point of light source C1 on the heat dissipation plate D. In addition, a solder paste D2 is added between the cavity D1 and the heat pipe E, and is then heated and melted at the cavity D1, such that the heat pipe E can be firmly welded at the cavity D1. The solder paste D2 can also achieve an effect of transmitting the heat energy C2, therefore the heat pipe E can be firmly fixed at the cavity D1, and the temperature can be homogenized in the heat dissipation plate D.

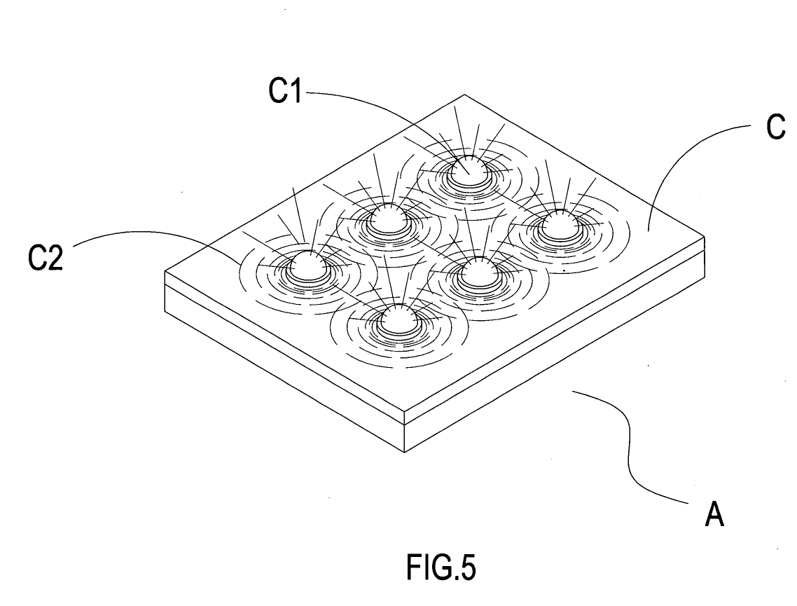

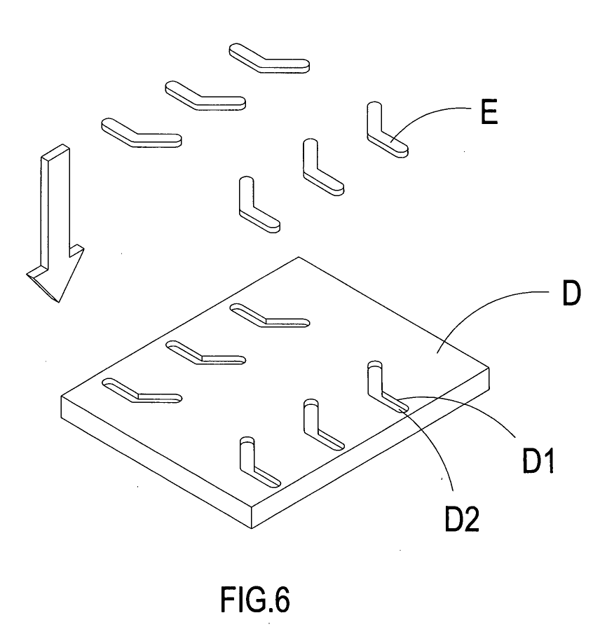

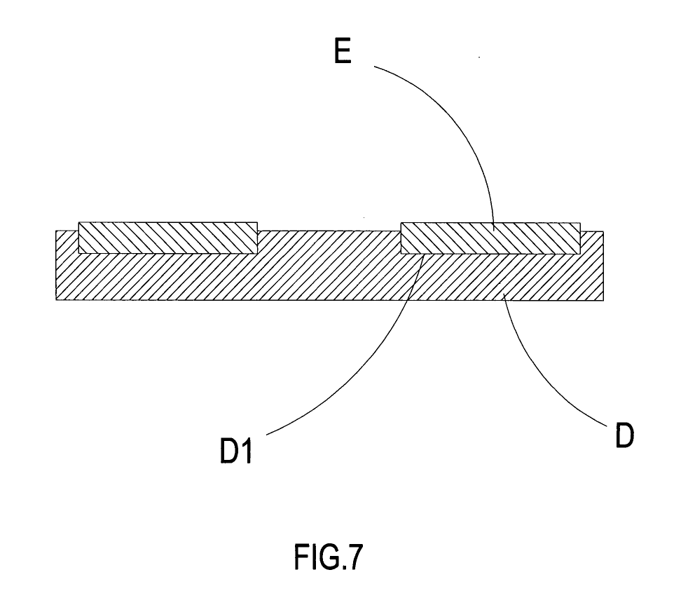

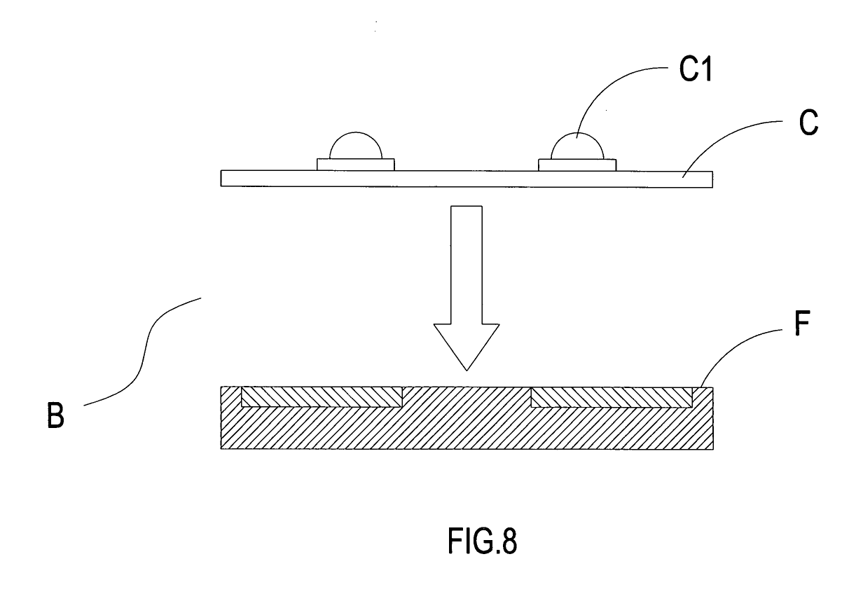

Referring to FIGS. 5 to 8, the heat dissipation plate D is embedded with one or more than one cavity D1 which is corresponding to one or more than one point of light source C1 in the light module C. The point of of light source C1 is a heating object of the light module C1 for creating the heat energy C2, which results in that the closer a position is to the point of light source C1 of light module C, the higher the heat energy C2 is.

The one or more than one cavity D1 is corresponding to the heat pipe E respectively, and the heat pipe E is installed in one or more than one cavity E. In addition, the solder paste D2 is added between the cavity D1 and the heat pipe E. After the heat pipes E are installed in the cavities D1, the heat dissipation plate D is heated, such that the heat pipes E can be tightly connected at the cavities D1, and the heat energy C2 can be effectively transmitted through the solder pastes D2. Next, the heat dissipation plate D and the heat pipes E are processed with a CNC (Computer Numerical Control) machine, such that the heat pipes E and the heat dissipation plate D can form into a complete plane F which can provide the light module C to be completely affixed on the heat dissipation plate D, thereby achieving effects of good heat transmission and temperature homogenization, and effectively preventing the light module C from creating a problem of chromatic aberration due to high heat.

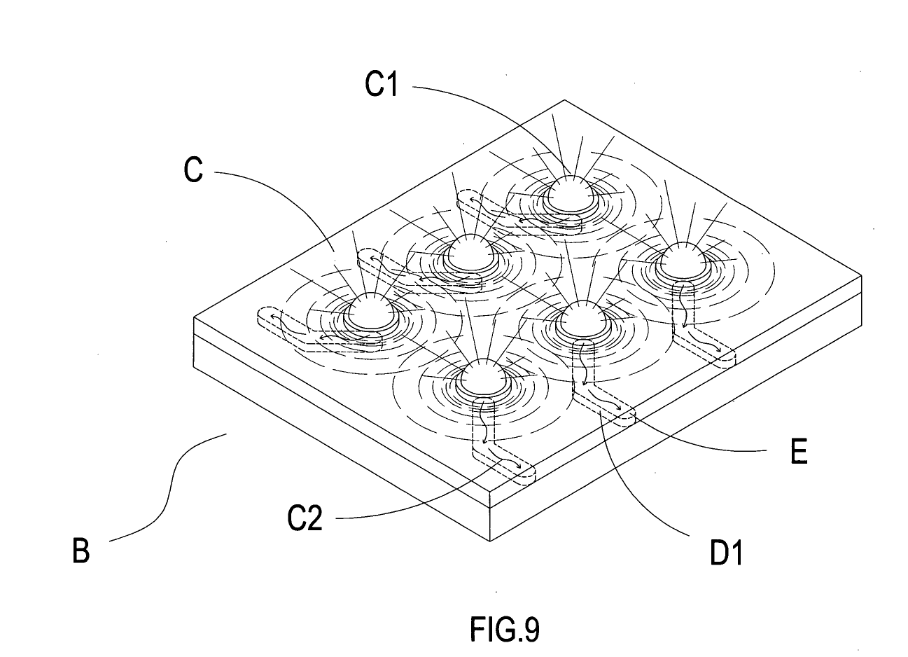

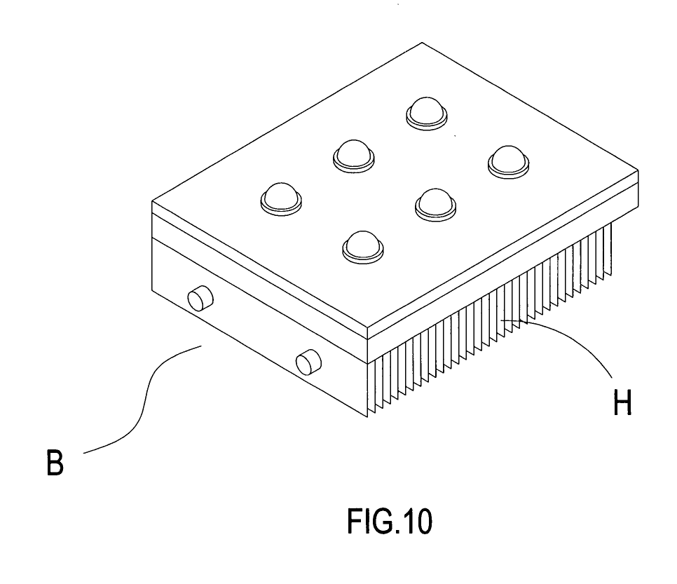

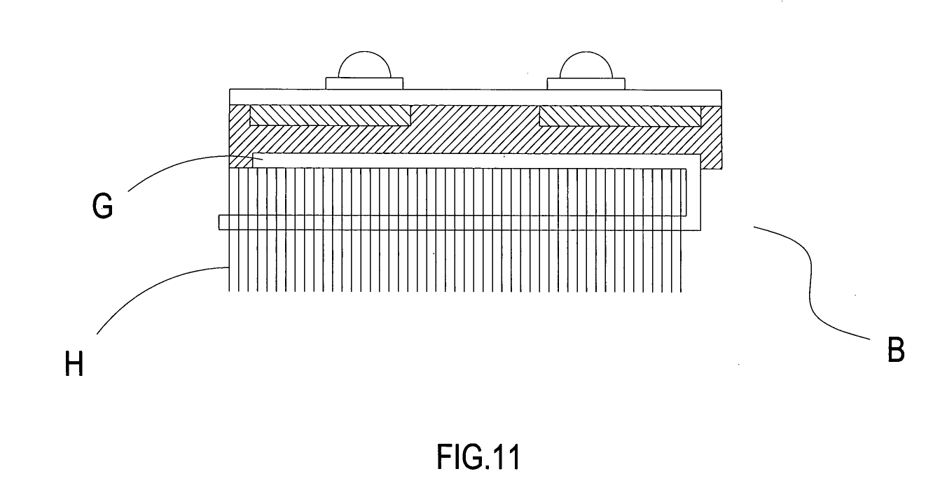

Referring to FIGS. 9 to 11, the heat pipes E are installed at the cavities D1 which are corresponding to the points of light sources C1 of light module C1, such that the heat pipes E can effectively receive the heat energy C2 from the points of light sources C1, and the heat energy C2 can be effectively and uniformly transmitted to low-temperature positions on the heat dissipation plate D, thereby enabling the heat dissipation plate D to effectively achieve an effect of homogenizing the temperature. Moreover, the heat dissipation plate D can be added additionally with a heat tube G to be connected to a heat dissipation device H, such that the backlight module B can achieve better effects of heat transmission, temperature homogenization, and heat dissipation, and the problem of chromatic aberration of the light module C due to the high heat can be prevented.

To further manifest the advancement and practicability of the present invention, the present invention is compared with a conventional backlight module as follow:

Shortcomings of a Conventional Backlight Module
1. The heat dissipation plate is only provided with the effect of heat dissipation.
2. According to item 1, the function of temperature homogenization cannot be achieved.
3. The positions of illuminant elements are still under the high-temperature state.
4. According to item 3, it is easy for the illuminant element to create the problem of chromatic aberration due to high heat.

Advantages of the Present Invention
1. In collaboration with the heat pipes, the heat dissipation plate can achieve the effects of heat dissipation and temperature homogenization.
2. The temperature at the point of light source can be effectively decreased.
3. The problem of chromatic aberration due to the excessively high temperature at the point of light source of light module can be effectively solved.
4. It has the advancement and practicability.
5. It can improve an industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A backlight module comprising a light module which includes one or more than one point of light source; a heat dissipation plate, which is a plate used to transmit the heat source, and is embedded with cavities corresponding to the points of light sources; and heat pipes, which are installed at the cavities of heat dissipation plate, and are used to uniformly transmit heat energy transmitted by the points of light sources on the heat dissipation plate.

2. The backlight module according to claim 1, wherein a solder paste is added between the heat pipe and the cavity, and is heated, such that the heat pipe is tightly connected at the cavity, and the heat energy is effectively transmitted by the solder paste.

3. The backlight module according to claim 1, wherein after the heat pipes are installed at the cavities, the heat pipes and the heat dissipation plate are processed with a CNC (Computer Numerical Control) machine, such that the heat pipes and the heat dissipation plate form into a complete plane.

4. The backlight module according to claim 1, wherein the heat dissipation plate is additionally added with a heat tube which is connected to a heat dissipation device, so as to provide a better effect of heat dissipation for the backlight module.

5. The backlight module according to claim 1, wherein the light module is further an integrated circuit, a CPU (Central Processing Unit), a storage device, an illumination device, a transformer, and other related device that generates heat.

6. The backlight module according to claim 1, wherein the heat dissipation plate and the heat pipes are further made by a copper material, an aluminum material, an alloy material, a ceramic material, and other related material that is provided with an effect of high heat transmission.
